(19) United States
(12) Patent Application Publication
(10) Pub. No.: US 2025/0005313 A1
(43) Pub. Date: Jan. 2, 2025

(54) RFID SAMPLING POINTS FOR A PARTICLE DETECTOR

(71) Applicant: ROCKWELL RESEARCH AND DEVELOPMENT GROUP, LLC, Portland, OR (US)

(72) Inventor: Steven William `Joseph, Portland, OR (US)

(21) Appl. No.: 18/758,717

(22) Filed: Jun. 28, 2024

Related U.S. Application Data
(60) Provisional application No. 63/510,742, filed on Jun. 28, 2023.
(60) Provisional application No. 63/510,764, filed on Jun. 28, 2023.
(60) Provisional application No. 63/511,662, filed on Jul. 2, 2023.

(51) Int. Cl. G06K 19/07; G06K 7/10; G06K 19/077

(52) U.S. Cl. CPC G06K 19/0717; G06K 7/10297; G06K 19/07724

(57) ABSTRACT

The present invention relates to the integration or attachment of RFID technology with sampling points of an aspirating particle detection system to improve identification, documentation, and retrieval of information. Embodiments of the present invention allows for electronic storage of data related to sampling points, enhancing maintenance and inspection processes.

### RELATED APPLICATIONS

The present application claims priority to U.S. Provisional Patent Application No. 63/510,742 filed on Jun. 28, 2023, U.S. Provisional Patent Application No. 63/510,764 filed on Jun. 28, 2023, and U.S. Provisional Patent Application No. 63/511,662 filed on Jul. 2, 2023, the entire contents of each are incorporated herein by reference.

### TECHNICAL FIELD

The present invention relates to the integration or attachment of RFID technology with sampling points of an aspirating particle detection system to improve identification, documentation, and retrieval of information. Embodiments of the present invention allows for electronic storage of data related to sampling points, enhancing maintenance and inspection processes.

### BACKGROUND

Particle detectors, such as aspirating smoke detectors, are engineered systems with one or more sampling points that draw air from an ambient environment to a detector, generally through a network of sampling pipes. The performance of these systems depends on various factors such as sampling point hole sizes, the number of sampling points, pipe length, and fan speed. These factors are calculated and used for validating installations and as benchmarks for inspections.

However, documentation is often unavailable, and sampling points lack identifiable information, posing challenges during tests and inspections. This can limit the effectiveness and usefulness of these systems.

Therefore, there is a need in the art for an invention that addresses these challenges, such as by integrating RFID technology with sampling points to store and retrieve information electronically, improving the efficiency and reliability of particle detection systems.

### SUMMARY OF THE INVENTION

According to an embodiment of the present invention, a chip-based sampling point device configured to be attached to a sampling pipe of a particle detector, comprising: a device body comprising a chip, an antenna, a connection means and an orifice, wherein the chip is configured to store sampling data and other data received from various computing devices, including, but not limited to, mobile devices and sampling sensors, wherein the antenna is communicatively connected to the chip and is configured to transmit data to one or more remote computing devices, wherein the connection means is configured to secure the chip-based sampling point device to the sampling pipe in a manner that allows for the orifice align with a hole in the sampling pipe.

According to an embodiment of the present invention, the chip is a Near Field Communication (NFC) chip configured to wirelessly communicate with a reader, such as an RFID capable mobile device.

According to an embodiment of the present invention, the chip is configured to store data selected from the group comprising: a location of the sampling point, hole size, sampling data, and associated detector information.

According to an embodiment of the present invention, the antenna is an integral part of the chip and is configured to enhance the communication range with remote computing devices.

According to an embodiment of the present invention, the device body is made of PET material, providing water resistance and durability in various environmental conditions.

According to an embodiment of the present invention, the connection means includes an adhesive layer configured to securely attach the device to the sampling pipe.

According to an embodiment of the present invention, the connection means includes a pipe clip configured to compression fit onto the sampling pipe.

According to an embodiment of the present invention, the orifice is aligned with an alignment window to ensure proper placement over the hole in the sampling pipe.

According to an embodiment of the present invention, the device further comprises an area for text and graphics, providing visual information about the sampling point.

According to an embodiment of the present invention, the chip includes a unique identifier (UID) that is password-protected for secure data access.

According to an embodiment of the present invention, the chip is configured to be read and written by a custom mobile device application.

According to an embodiment of the present invention, the connection means includes a barbed fitting for attaching a tube or hose to the sampling pipe.

According to an embodiment of the present invention, the chip is configured to store commissioning benchmark data and subsequent test and inspection data.

According to an embodiment of the present invention, the device body includes an adhesive-free area to facilitate handling and positioning during installation and prevent contaminants from building up around the orifice.

According to an embodiment of the present invention, the chip and antenna is over-molded into the device body for enhanced protection against environmental factors.

According to an embodiment of the present invention, the device body is configured to fit various pipe diameters through adjustable connection means.

According to an embodiment of the present invention, the data stored on the chip can be used to identify and validate the proper performance of the sampling point within a particle detection system.

According to an embodiment of the present invention, the device is configured to receive information related to sampling data and sampling point device data from a computing device, such as a mobile computing device or sampling sensor.

According to an embodiment of the present invention, the chip is configured to alert maintenance personnel when the sampling point requires inspection or replacement based on stored performance data.

### BRIEF DESCRIPTION OF THE DRAWINGS

Accompanying this written specification is a collection of drawings of exemplary embodiments of the present disclosure. One of ordinary skill in the art would appreciate that these are merely exemplary embodiments, and additional and alternative embodiments may exist and still within the spirit of the disclosure as described herein.

FIG. 1 is a schematic illustration of a self-adhesive label with RFID chip, antenna, and appropriately sized sampling orifice;

FIG. 2 is a schematic illustration of a sampling pipe with RFID chip and antenna attached;

FIG. 3 is a schematic illustration of a saddle type pipe clip sampling point fitting with RFID chip and antenna;

FIG. 4 is a schematic illustration of a saddle type pipe clip sampling point fitting with RFID chip and antenna as attached to a sampling pipe of a particle detector;

FIG. 5 is a diagram showing a remote sampling point with RFID chip and antenna interconnected to a sampling pipe of a particle detector;

FIG. 6A is a schematic illustration of a saddle type pipe clip with a sampling point securing means; and

FIG. 6B is a schematic illustration of a saddle type pipe clip with a sampling point securing means.

### DETAILED DESCRIPTION

According certain embodiments of the present invention, a device comprising an RFID tag/label, or other Near Field Communication (NFC) for attachment or integration with one or more sampling points of a particle detector is disclosed.

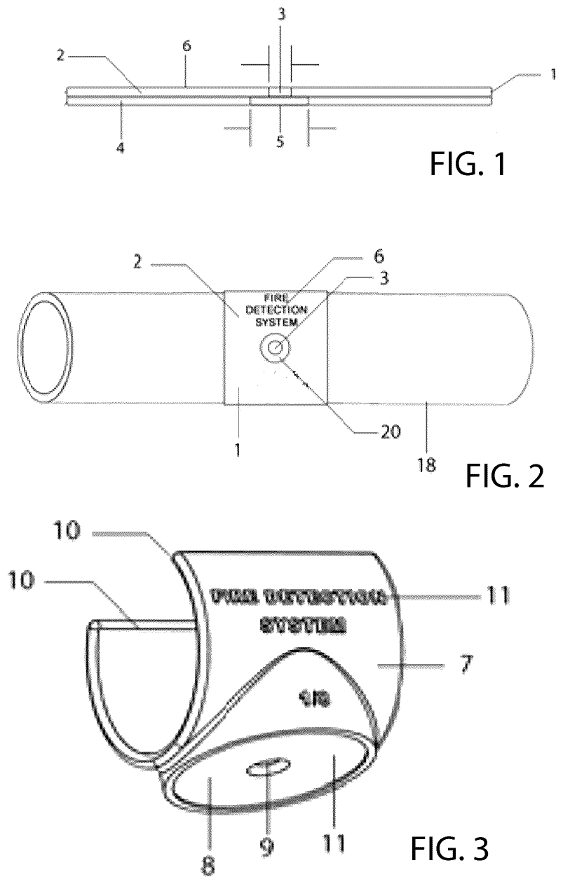

Turning now to FIG. 1, an exemplary embodiment of the present invention is shown. In this embodiment, a self-adhesive label with RFID chip and antenna are shown in conjunction with a sample hole orifice of a particle detector. In a preferred embodiment, a self-adhesive label 1 is configured to attach the RFID label over holes placed in a sampling pipe of a particle detector. The label 1 may be constructed from any appropriate materials, including, but not limited to, PET material, which is waterproof/resistant and able to withstand moderate moisture levels. This feature ensures durability and reliability in various environmental conditions. One of ordinary skill in the art would appreciate that there are numerous materials that could be utilized with the label 1, and embodiments of the present invention are contemplated for use with any appropriate materials.

In preferred embodiments, the device further comprises a RFID chip and antenna 2. In certain embodiments, the RFID chip and Antenna 2 are embedded within the label and are configured to provide a means to store and transmit data wirelessly. In other embodiments, the RFID chip and antenna 2 may be formed on one side of the label, rather than embedded within the label. One of ordinary skill in the art would appreciate that there are numerous configurations that could be possible for the location of the RFID chip and antenna 2, and embodiments of the present invention are contemplated with any such configurations.

In certain embodiments, the antenna, which is part of the RFID system, allows for the communication of information between the chip and an external reader. This setup allows for documenting and retrieving information about the sampling point. In preferred embodiments, the RFID chip includes a unique identifier (UID) and on-board memory, which can store data such as the sampling point's hole size, custom name, associated detector, location, commissioning and inspection data.

In preferred embodiments of the present invention, the data stored with the RFID chip, and/or access to connection with the RFID chip, may be secured, such as via password protection or other security means (e.g., two factor authentication, code generators). In these embodiments, the data may be accessed in an appropriate manner, such as using a custom app on a mobile device, enabling users to scan the tag and retrieve stored information effortlessly.

While in the detailed description herein RFID technology is a focus, one of ordinary skill in the art would appreciate that The actual communication technology employed could include, but is not limited to, various types of communications means, such as UHF, HF, NFC, and LF, WIFI, Bluetooth, BTLE and/or cellular, depending on the specific requirements of the application. For instance, NFC may be advantageous due to its short-range communication capability, which is ideal for ensuring secure and reliable data exchange when the label is scanned with a mobile device. In other embodiments, such as where a power source is available, higher power consumption means could be used, such as WIFI. One of ordinary skill in the art would appreciate that there are numerous types of communication technologies that could be used with embodiments of the present invention, and embodiments of the present invention are contemplated for use with any form of communication technologies.

A sample hole orifice 3 in the label allows air samples to be drawn from the ambient environment into the sampling pipe of a particle detector. This orifice is ideally aligned with the corresponding hole in the sampling pipe, which is facilitated by the alignment window. In one embodiment of the invention, the orifice can be an engineered size according to a calculation program used to validate performance of particle detectors. This way, technicians do not need to drill precise hole sizes. Instead, they simply drill a larger diameter hole and the orifice in the label itself serves as the appropriately sized orifice.

An adhesive layer 4 ensures that the label securely attaches to the sampling pipe. In preferred embodiments of the present invention, the adhesive used is double-sided, providing a strong bond to withstand the operational conditions of the particle detection system. An adhesive-free area 5 may be included to facilitate handling during installation, ensuring that the label can be positioned accurately without sticking prematurely. The adhesive free area also serves to keep particulate and other contaminants from building up around the orifice.

A text and graphics area 6 may be included on the label and is designated for printing text and graphics, which may include the sampling point's identifier, operational parameters, and other relevant information. This visual information complements the data stored on the RFID chip, providing immediate reference for personnel during inspections and maintenance.

Turning now to FIG. 2, an exemplary embodiment of a RFID chip and antenna attached to a sampling pipe of a particle detector is shown. In this figure, a sampling pipe 18 is shown with the RFID chip and antenna 2 attached. Notably, an alignment window 20 is shown, which aids in the alignment and attachment of the RFID chip and antenna 2 to be perfectly fit over the hole orifice 3 of the sampling pipe 18.

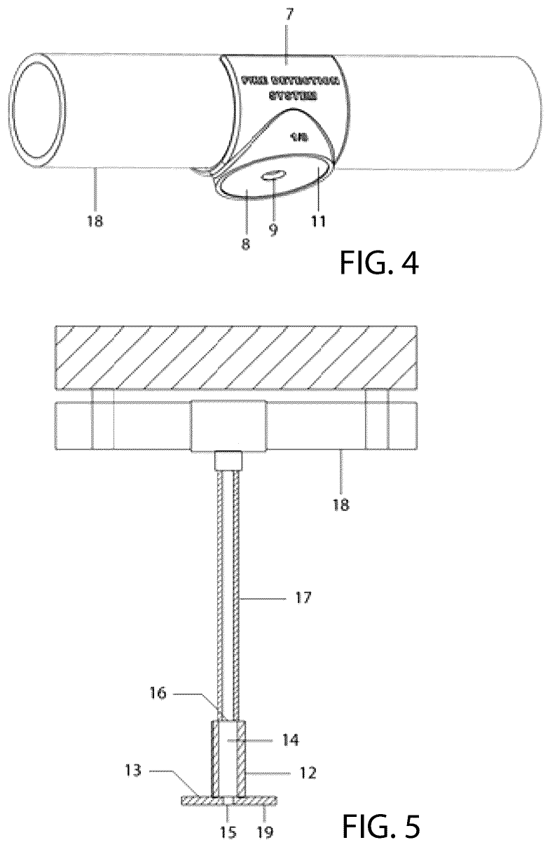

Turning now to FIGS. 3 and 4, an exemplary embodiment of a RFID chip and antenna, in accordance with an embodiment of the present invention. FIG. 3 shows a RFID chip and antenna attached to or integrated with a saddle type sample point pipe clip. FIG. 4 shows the RFID chip and antenna attached to a sampling pipe of a particle detector via the pipe clip. In this embodiment, the pipe clip 7 offers an alternative method for attaching or integrating the RFID chip and antenna 2 with sampling points. In certain embodiments, the pipe clip can be molded with the RFID and antenna components integrated into the pipe clip. In other embodiments, the pipe clip may have an RFID chip and antenna attached to it in the form of a label via an adhesive means and then secured to the sampling pipe 18.

Similar to the self-adhesive label, the RFID chip and antenna 8 on or in the pipe clip stores and transmits data related to the sampling point. In certain embodiments, the RFID chip and antenna are securely embedded within the pipe clip, ensuring durability and protection against environmental factors. In other embodiments, the RFID chip and antenna may be attached in the form of a label via an adhesive, as detailed elsewhere herein. In these embodiments, the antenna facilitates the wireless communication of data when scanned by an RFID reader, such as an RFID capable mobile device.

In these embodiments, the pipe clip may include a hole 9 for drawing samples. Ideally, the hole 9 would be aligned with the sampling pipe's corresponding hole. This design ensures that the samples are accurately collected from the intended ambient environment.

Various methods can be employed to fasten the pipe clip to the sampling pipe, including, but not limited to, gluing or compression fitting 10. These methods provide flexibility in installation, allowing the pipe clip to be securely attached without compromising the integrity of the sampling pipe. One of ordinary skill in the art would appreciate that there are numerous means for securing the pipe clip to the sampling pipe, and embodiments of the present invention are contemplated for use with any such securing means.

Similar to the label embodiments, pipe clip embodiments may contain an area for text and graphics 11. This area provides immediate visual information about the sampling point, complementing the electronically stored data on the RFID chip.

Turning now to FIG. 5, an embodiment of the present invention is shown utilizing a remote sampling point fitting. In certain embodiments, the remote sampling point fitting 12 extends the flexibility of integrating the RFID chip and antenna technology within sample points that are distal from the main sampling pipe of a particle detector. In certain embodiments, an existing remote sampling point fitting is affixed with an adhesive version of an embodiment of the present invention, as detailed elsewhere herein.

In these embodiments, a RFID chip and antenna 13 may be embedded within or attached to the remote sampling point fitting 12, the RFID chip store and transmit data related to the remote sampling point. This setup allows for the collection and retrieval of information even in locations where direct access to the main sampling pipe is challenging.

In these embodiments, a hollow body 14 of the fitting may include a sampling hole 15 at an end, side or other location, through which samples are drawn. These designs ensures that samples from the remote location is accurately sampled and analyzed by the particle detection system.

Further, in certain embodiments, the fitting 12 includes an outlet 16 for connecting to the sampling pipe 18 via an extension piece 17. The extension piece could be, for instance, a hose, tube, pipe or any other appropriate part that allows for the samples to pass through the body of the extension piece 17. This connection method allows for flexibility in installation, enabling the remote fitting to be positioned optimally for effective air sampling. One of ordinary skill in the art would appreciate that there are numerous types of extension pieces that could be utilized with embodiments of the present invention, and embodiments of the present invention are contemplated for use with any appropriate extension piece.

As with the other embodiments, the device affixed or integrated with the remote fitting may include an area for text and graphics 19, providing immediate reference information alongside the electronically stored data.

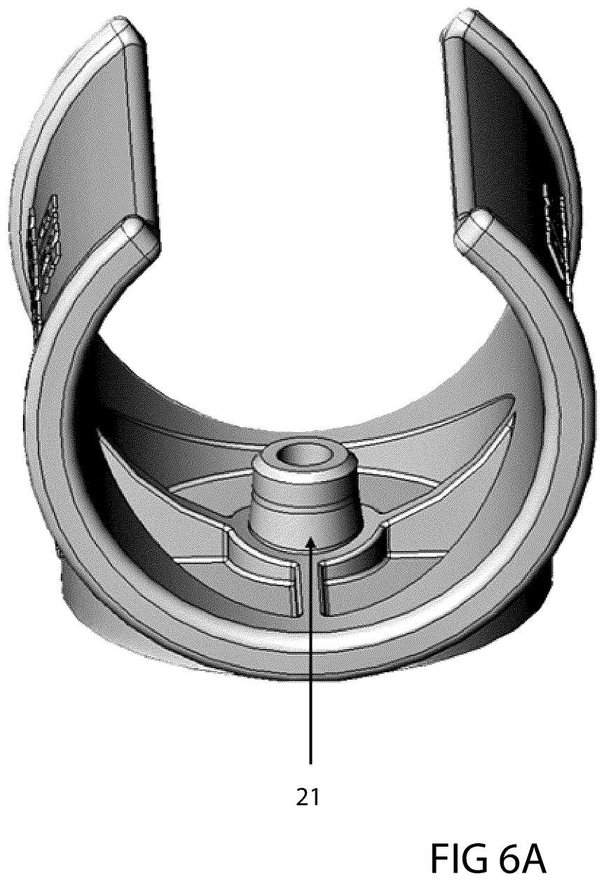

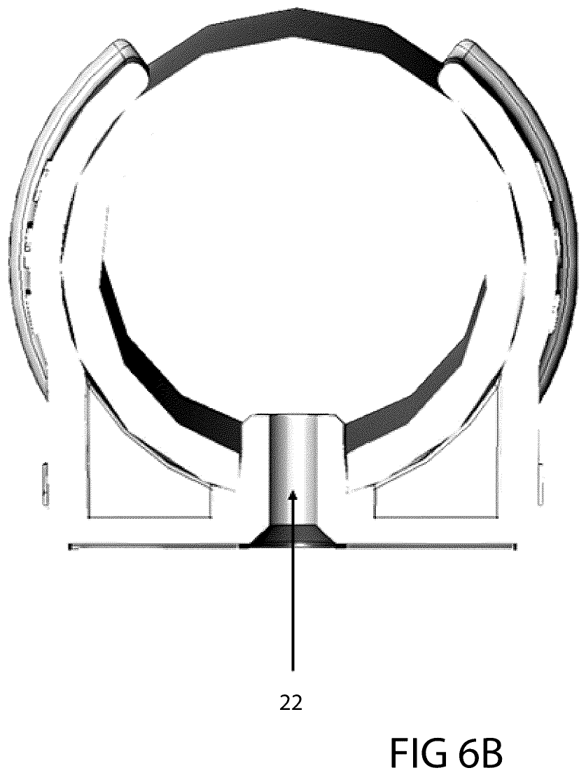

Turning now to FIG. 6A-6B, embodiments of the present invention in the form of a pipe clip are shown. In certain embodiments, an extending post 21 provides for the pipe clip to be secured in position as the extending post 21 is inserted into a hole in the sampling pipe, preventing movement of the pipe clip. In certain embodiments, the extending post 22 also acts to provide a compression fitting, allowing for samples to exit the sample point at a rate increased by pressure created by the reduction in diameter of the hole.

Traditionally, a computer program, such as the ones utilized on various embodiments of the RFID chip, and a mobile application or other application that interfaces therewith, may include a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

It will be appreciated that computer program instructions related to the applications that may interface with the device described herein may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

While the foregoing drawings and description set forth functional aspects of the disclosed systems, no particular arrangement of software for implementing these functional aspects should be inferred from these descriptions unless explicitly stated or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

While multiple embodiments are disclosed, still other embodiments of the present disclosure will become apparent to those skilled in the art from this detailed description. There may be aspects of this disclosure that may be practiced without the implementation of some features as they are described. It should be understood that some details have not been described in detail in order to not unnecessarily obscure the focus of the disclosure. The disclosure is capable of myriad modifications in various obvious aspects, all without departing from the spirit and scope of the present disclosure. Accordingly, the drawings and descriptions are to be regarded as illustrative rather than restrictive in nature

What is claimed is:

1. A chip-based sampling point device configured to be attached to a sampling pipe, comprising:
a device body comprising a chip, an antenna, a connection means and an orifice,
wherein the chip is configured to receive and store sampling data from samples passing through the orifice,
wherein the antenna is communicatively connected to the chip and is configured to transmit data to one or more remote computing devices,
wherein the connection means is configured to secure the chip-based sampling point device to the sampling pipe in a manner that allows for the orifice to align with a hole in the sampling pipe of a particle detector.

2. The chip-based sampling point device of claim 1, wherein the chip is a Near Field Communication (NFC) chip configured to wirelessly communicate with a mobile device.

3. The chip-based sampling point device of claim 1, wherein the chip is configured to store data selected from the group comprising: a location of the sampling point, hole size, sampling data and associated detector information.

4. The chip-based sampling point device of claim 1, wherein the antenna is an integral part of the chip and is configured to enhance the communication range with remote computing devices.

5. The chip-based sampling point device of claim 1, wherein the device body is made of PET material, providing water resistance and durability in various environmental conditions.

6. The chip-based sampling point device of claim 1, wherein the connection means includes an adhesive layer configured to securely attach the device to the sampling pipe.

7. The chip-based sampling point device of claim 1, wherein the connection means includes a saddle type pipe clip configured to compression fit onto the sampling pipe.

8. The chip-based sampling point device of claim 1, wherein the orifice is aligned with an alignment window to ensure proper placement over the hole in the sampling pipe.

9. The chip-based sampling point device of claim 1, wherein the device further comprises an area for text and graphics, providing visual information about the sampling point.

10. The chip-based sampling point device of claim 1, wherein the chip includes a unique identifier (UID) that is password-protected for secure data access.

11. The chip-based sampling point device of claim 1, wherein the chip is configured to be read and written by a custom mobile device application.

12. The chip-based sampling point device of claim 1, wherein the connection means includes a a tube or hose to distally connect a remote sample point to the sampling pipe.

13. The chip-based sampling point device of claim 1, wherein the chip is configured to store commissioning benchmark data and subsequent test and inspection data.

14. The chip-based sampling point device of claim 1, wherein the device body includes an adhesive-free arean.

15. The chip-based sampling point device of claim 1, wherein the chip and the antenna are over-molded into the device body for enhanced protection against environmental factors.

16. The chip-based sampling point device of claim 1, wherein the device body is configured to fit various pipe diameters through adjustable connection means.

17. The chip-based sampling point device of claim 1, wherein the data stored on the chip can be used to validate the proper installation and maintenance of the sampling point within a particle detection system.

18. The chip-based sampling point device of claim 1, wherein the device is configured to transmit data to a cloud-based storage system for remote monitoring and analysis.

19. The chip-based sampling point device of claim 1, wherein the chip is configured to alert maintenance personnel when the sampling point requires inspection or replacement based on stored performance data.
